(19) United States
(12) Patent Application Publication
(10) Pub. No.: US 2025/0203266 A1
(43) Pub. Date: Jun. 19, 2025

(54) A HEARING DEVICE AND METHOD FOR DETECTING IF THE HEARING DEVICE IS WORN BY A USER

(71) Applicant: GN AUDIO A/S, Ballerup (DK)

(72) Inventors: Chaoming CHEN, Ballerup (DK); Zehao CHEN, Ballerup (DK)

(21) Appl. No.: 18/848,698

(22) PCT Filed: Apr. 7, 2022
(86) PCT No.: PCT/CN2022/085447

§ 371 Date: Sep. 19, 2024

(51) Int. Cl. H04R 1/10

(52) U.S. Cl. CPC H04R 1/1041; H04R 1/1008; H04R 1/1016; H04R 1/1025; H04R 2420/07

(57) ABSTRACT

Disclosed is a method and a hearing device configured to detect if the hearing device is being worn by a user, the hearing device being configured to be worn on an ear or in an ear of the user, the hearing device comprising: a housing; an acoustic output transducer for transmitting audio into the ear of the user, the acoustic output transducer being arranged in the housing; an electrical circuit arranged in the housing; a battery arranged in the housing; wherein the hearing device comprises a first electrically conductive point and a second electrically conductive point, where the first electrically conductive point and the second electrically conductive point are arranged to be in contact with the skin of the user's ear, when the user is wearing the hearing device in its intended operational position on/in the ear of the user; wherein the electrical circuit is configured to detect when the first electrically conductive point and the second electrically conductive point are in contact with the skin of the user's ear, whereby the hearing device detects whether the hearing device is worn by the user.

### FIELD

The present invention relates to hearing devices. More specifically, the disclosure relates to a method and a hearing device configured to detect if the hearing device is being worn by a user. The hearing device is configured to be worn on an ear or in an ear of the user. The hearing device comprises a housing, an acoustic output transducer for transmitting audio into the ear of the user, an electrical circuit and a battery.

### BACKGROUND

Today most hearing device, such as headsets, do not have an in-ear detection feature, thus they will continue to play audio, e.g. from music or movies, even if the earphone(s), such as earbud(s), are not worn in the ear anymore, e.g. because the user has taken them out. This wastes power of the hearing device and leads to incomplete music or movie for the user. Thus, there is a need for an improved method and hearing device configured to detect if the hearing device is being worn by a user.

### SUMMARY

Disclosed is a hearing device configured to detect if the hearing device is being worn by a user. The hearing device being configured to be worn on an ear or in an ear of the user. The hearing device comprises a housing. The hearing device comprises an acoustic output transducer for transmitting audio into the ear of the user. The acoustic output transducer being arranged in the housing. The hearing device comprises an electrical circuit arranged in the housing. The hearing device comprises a battery arranged in the housing. The hearing device comprises a first electrically conductive point and a second electrically conductive point. The first electrically conductive point and the second electrically conductive point are arranged to be in contact with the skin of the user's ear, when the user is wearing the hearing device in its intended operational position on/in the ear of the user. The electrical circuit is configured to detect when the first electrically conductive point and the second electrically conductive point are in contact with the skin of the user's ear, whereby the hearing device detects whether the hearing device is worn by the user.

The hearing device is configured to detect if the hearing device is being worn by a user. The hearing device may also be configured as a headset for audio communication, such as phone calls, streaming of media content etc. The headset may be configured as a hearing aid for compensating for a hearing loss of the user.

The hearing device is configured to be worn on an ear or in an ear of the user. If the hearing device is an on-ear or over-ear hearing device, the earphone(s) of the hearing device is/are arranged on the ear of the user. If the hearing device is an in-ear hearing device, the earphone(s) of the hearing device is/are arranged in the ear of the user, such as in the ear canal. The hearing device may comprise one or two earphones. Earphones may also be called earbuds. On the hearing device, housing and/or earphone, there may be attached an eargel or dome, an earwing or retention etc.

The hearing device comprises a housing. The housing may be a rigid or flexible shell or compartment comprising one or more components of the hearing device.

The hearing device comprises an acoustic output transducer for transmitting audio into the ear of the user. The acoustic output transducer is arranged in the housing. The acoustic output transducer may be a speaker, loudspeaker, receiver, etc. The transmitting audio may be streamed media content, such as music, radio, video sound, podcast, audio book etc. The transmitting audio may be speech signals to the user in a phone call with a far-end caller.

The hearing device comprises an electrical circuit arranged in the housing. The electrical circuit is configured for detecting electrical voltage, electrical resistance, electrical current, electrical impedance etc. The electrical circuit may be a detection circuit.

The hearing device comprises a battery arranged in the housing. The battery may be a rechargeable battery or replaceable battery. Thus if the battery is rechargeable, the battery may be configured to remain in the housing of the hearing device and be recharged daily, weekly, monthly etc. by using a charging device. If the battery is a replaceable battery, the battery may be replaced by a new battery when the battery is depleted.

The hearing device comprises a first electrically conductive point and a second electrically conductive point. The first electrically conductive point and the second electrically conductive point may be arranged or provided in/on the housing. The electrically conductive points may be electrodes. The electrically conductive points may be detection electrodes.

The first electrically conductive point and the second electrically conductive point are arranged to be in contact with the skin of the user's ear, when the user is wearing the hearing device in its intended operational position on/in the ear of the user. Thus, the first electrically conductive point and the second electrically conductive point are arranged, provided or configured in the hearing device, such as in/on the housing, in a position or location where the first electrically conductive point and the second electrically conductive point are in contact with the user's skin, when the user is wearing the hearing device in its intended position in/on the ear. When the first electrically conductive point and the second electrically conductive point are in contact with the user's skin, the electrical circuit will form a closed loop, because human skin is electrically conductive. When the first electrically conductive point and/or the second electrically conductive point are not in contact with the user's skin, the electrical circuit will not form a closed loop.

Thereby, the electrical circuit is configured to detect when the first electrically conductive point and the second electrically conductive point are in contact with the skin of the user's ear, whereby the hearing device detects whether the hearing device is worn by the user.

Thus, when the first electrically conductive point and the second electrically conductive point are both in contact with the user's skin, the electrical circuit will form a closed loop, and the hearing device will detect that the hearing device is being worn by the user. Whereas, when the first electrically conductive point and/or the second electrically conductive point are not in contact with the user's skin, the electrical circuit will not form a closed loop, and the hearing device will detect that the hearing device is not being worn by the user.

The electrical circuit is in contact with the first electrically conductive point and the second electrically conductive point, and thereby the electrical circuit is configured to detect when the first electrically conductive point and the second electrically conductive point are in contact with the skin of the user's ear. The first electrically conductive point and the second electrically conductive point may made of conductive silicone to make them detection electrodes. The first electrically conductive point and the second electrically conductive point may be connected to the electrical circuit via a metal contact on a frame. The electrical circuit may be connected to a micro control unit (MCU) configured to control and determine actions and functions of the hearing device. The result output of the detection of the electrical circuit may be provided to the micro control unit (MCU) to determine actions, such as to continue to transmit audio via the acoustic output transducer, or such as to stop transmitting audio via the acoustic output transducer.

The first electrically conductive point and the second electrically conductive point may be made of an electrically conductive material. The first electrically conductive point and the second electrically conductive point may be on a conductive part of the hearing device, such as an eargel, earwing, ear cushion, and/or back cover of a hearing device etc. The first electrically conductive point and the second electrically conductive point may be points on the conductive part of the hearing device. The first electrically conductive point and the second electrically conductive point may be the points where the connection to the electrical circuit are.

The housing may be made of non-conductive material for ensuring that the first and second electrically conductive points on the conductive parts, such as the earwing and/or eargel, can be detected without any influence from any other conductive material on/at the housing.

It is an advantage of the hearing device that it detects whether the hearing device is worn by the user or not. It is an advantage that the hearing device detects whether it is worn or not, as this detection may enrich the hearing device functions in various ways.

For example, it is an advantage to detect if the hearing device is worn by user, because audio should only continue to be transmitted if the hearing device is worn. Audio should stop being transmitted if the hearing device is not worn.

This is an advantage, because it will save battery to stop audio transmission when the hearing device is not worn.

It is also an advantage to stop transmission of audio if the hearing device is not worn, because hereby the user will not miss part of a podcast, an audio book, etc. which the user is listening to.

Thus, an advantage of the present hearing device and method is the ability to know the wearing status of the hearing device, as this can enrich the hearing device's functions, such as playing music normally when wearing the hearing device, and automatically stopping playing when the hearing device is removed.

Other functions of the hearing device besides audio transmission, may be automatic noise cancellation (ANC) and hear-through. These functions also requires battery power, thus, it is an advantage to detect when the hearing device is not worn, because then ANC and hear-through can be stopped, and this will save battery power.

Streaming of audio may be from an external electronic device, such as a smartphone, tablet, computer, pc etc. The electronic device may run a software application, e.g. an app, with media content, e.g. comprising the audio. Thus, the audio may be transmitted in the hearing device when the hearing device is connected/paired with the electronic device. If the hearing device is not connected/paired with the electronic device, the audio stream may be transmitted in the speaker(s) of the electronic device.

Thus, it is an advantage that the audio streaming may be automatically switched back to being transmitted from the speakers of the electronic device, instead of from the hearing device, when the hearing device detects that it is not worn by the user, even when the hearing device is still connected/paired with the electronic device.

Most hearing device, such as headsets, today do not have an in-ear detection feature, thus they will continue to play audio, e.g. from music or movies, even if the earphone(s), such as earbud(s), are not worn on the ear. It wastes power and leads to incomplete music or movie.

A prior art solution is to use an infrared proximity sensor in earbuds. This prior art solution requires an infrared proximity sensor, which is costly and has a high occupation space for the product. At the same time, the average power consumption will increase due to the continuous transmission and reception by the sensor. Furthermore, limited to the theory of the proximity sensor, it is impossible to recognize whether the ear or other object is blocked, which means that if the earbud is removed from the ear but the sensor windows is blocked by other objects, it may cause a false trigger.

It is an advantage of the present hearing device and method that the power consumption is lower than the prior art solution of using an infrared proximity sensor. Furthermore, it is an advantage of the present hearing device and method that it cannot cause the false triggers which the infrared proximity sensor can, as there is no sensor window in the present hearing device which can be blocked by other objects than the human skin.

It is an advantage of the present hearing device that it is low cost and low space required. The hearing device may only need a conductive silicone instead of the standard/original silicone on the housing, and may only make a metal contact pole to connect to the internal circuit. For the circuit part, only one N-MOS and a few passive components may be needed.

It is an advantage if the two electrically conductive points have a “large” distance to each other, because thereby the difference in electrical resistance/voltage will also be larger, and this may improve the detection of whether the hearing device is worn in/on the ear of the user or not.

The distance between the two electrically conductive points may be “large” or increased e.g. if the two points are on two different earphones of the hearing device or if e.g. the two points are positioned in opposite ends of the earphone of the hearing device.

The distance between the two electrically conductive points may be “large” or increased e.g. if the two points are on an earwing and on an eargel, respectively, and not both on the same earwing or eargel.

However, the detection of whether the hearing device is worn in/on the ear of the user or not, may be performed even if the two points are closer to each other.

According to an aspect, disclosed is a method in a hearing device for detecting if the hearing device is being worn by a user. The hearing device being configured to be worn on an ear or in an ear of the user, the hearing device comprising: a housing; an acoustic output transducer for transmitting audio into the ear of the user, the acoustic output transducer being arranged in the housing; an electrical circuit arranged in the housing; a battery arranged in the housing. The hearing device comprises a first electrically conductive point and a second electrically conductive point. The first electrically conductive point and the second electrically conductive point are arranged to be in contact with the skin of the user's ear, when the user is wearing the hearing device in its intended operational position on/in the ear of the user. The method comprises detecting, by the electrical circuit, when the first electrically conductive point and the second electrically conductive point are in contact with the skin of the user's ear, whereby the hearing device detects whether the hearing device is worn by the user.

In some embodiments, when the acoustic output transducer is transmitting audio, then:
in accordance with a determination that the hearing device detects that the hearing device is worn by the user: the acoustic output transducer continues to transmit audio, and
in accordance with a determination that the hearing device detects that the hearing device is not worn by the user: the acoustic output transducer stops to transmit audio.

It is an advantage to stop transmitting audio to save battery. It is a further advantage to stop transmission of audio if the hearing device is not worn, so that user will not miss part of a podcast, an audio book, etc.

In some embodiments, the electrical circuit is configured to detect when the first electrically conductive point and the second electrically conductive point are in contact with the skin of the user's ear by measuring a difference in electrical voltage and/or in electrical resistance between the first electrically conductive point and the second electrically conductive point.

In some embodiments, the electrical circuit is configured to detect when the first electrically conductive point and the second electrically conductive point are in contact with the skin of the user's ear by measuring a change in electrical voltage and/or in electrical resistance at the first electrically conductive point or at second electrically conductive point. The change may be over a time period or time interval. The change may happen when the user either puts on/in the hearing device or when the user removes the hearing device from the ear. The change may be at the first electrically conductive point. The change may be at second electrically conductive point.

In some embodiments, the electrical circuit is configured to detect when the first electrically conductive point and the second electrically conductive point are in contact with the skin of the user's ear by measuring if the difference in electrical voltage and/or in electrical resistance between the first electrically conductive point and the second electrically conductive point is above or below a predefined threshold.

In some embodiments, the electrical circuit is configured to detect when the first electrically conductive point and the second electrically conductive point are in contact with the skin of the user's ear by measuring if the change in electrical voltage and/or in electrical resistance at the first electrically conductive point is above or below a predefined threshold. The change may be over a time period or time interval.

In some embodiments, the electrical circuit is configured to detect when the first electrically conductive point and the second electrically conductive point are in contact with the skin of the user's ear by measuring if the change in electrical voltage and/or in electrical resistance at the second electrically conductive point is above or below a predefined threshold. The change may be over a time period or time interval.

The predefined threshold may be different for men, women, children. The predefined threshold may be different for different weather temperature. The predefined threshold may be different when the user is doing sport compared to when the user it not doing sport, because the skin resistance will be lower if the user sweats. Thus the predefined threshold may be a setting in the hearing device which can be adapted relative to information regarding the gender, age, country of residence, activity level etc. of the user.

In some embodiments, the first electrically conductive point and the second electrically conductive point are made of an electrically conductive material. The electrical resistance may be less than 100 kΩ of a finished goods. The material electrical resistivity may be considered. A lower resistivity may be better, but for a larger resistivity, the material may be made wider but thinner so that the total resistance is low enough.

In some embodiments, the electrically conductive material is an electrically conductive silicone, or an electrically conductive rubber, or an electrically conductive leatherette. The material may be made conductive by mixing metal powder or carbon into the material. For the conductive material, such as conductive silicon, it may be made conductive by the incorporation of special grades of conductive carbon black or various conductive fillers such as metal spheres, metal such as gold, silver or copper, or coated spheres, such as copper or silver coated glass or metal spheres. The level of electrical conductivity depends on the conductivity of the filler.

In some embodiments, the hearing device is a headset for transmitting audio from and/or to an external electronic device connected to the headset. The external electronic device may be a smartphone, tablet, computer, pc etc. The connection between the hearing device and the electronic device may be a wireless connection, such as via Bluetooth (BT), Wi-Fi, WLAN etc. or a wired connection via a cable. The transmitted audio may be media content, such as radio, music, podcast, audio book etc., and/or speech signals to the user in a phone call with a far-end caller.

In some embodiments, the hearing device is an in-ear hearing device, or an on-ear hearing device, or an over-ear hearing device. The hearing device is configured to be worn on an ear or in an ear of the user. If the hearing device is an on-ear or over-ear hearing device, the earphone(s) of the hearing device is/are arranged on the ear of the user. If the hearing device is an in-ear hearing device, the earphone(s) of the hearing device is/are arranged in the ear of the user, such as in the ear canal. The hearing device may comprise one or two earphones. The earphone(s) may be circumaural, supra-aural etc. Earphones may also be called earbuds. On the hearing device, housing and/or earphone, there may be attached an eargel or dome, an earwing or retention etc.

In some embodiments, the first electrically conductive point and/or the second electrically conductive point are arranged on the housing of an in-ear hearing device. The first electrically conductive point and/or the second electrically conductive point may be made of a conductive material. The conductive material, e.g. silicone, can be put on the back cover of the hearing device, e.g. housing, as accessories. Or the conductive material, e.g. silicone, can be over-molded to the back cover especially for non-earwing design.

In some embodiments, the first electrically conductive point and/or the second electrically conductive point are arranged on an earwing and/or on an eargel arranged on an in-ear hearing device. For example, both electrically conductive points are arranged on an earwing of the hearing device, or both electrically conductive points are arranged on an eargel of the hearing device, or one electrically conductive point is arranged on an earwing and the other electrically conductive point is arranged on an eargel. Alternatively, one electrically conductive point is arranged on the housing, such as on the back cover as explained in the embodiment above, and the other electrically conductive point is arranged on either an earwing or an eargel of the hearing device.

In some embodiments, the first electrically conductive point and/or the second electrically conductive point are arranged on a first earphone and/or on a second earphone of the housing of an on-ear or an over-ear hearing device. For example, both electrically conductive points are arranged on the first earphone, or both electrically conductive points are arranged on the second earphone, or one electrically conductive point is arranged on the first earphone and the other electrically conductive point is arranged on the second earphone. The first earphone and/or the second earphone may comprise an ear cushion. The ear cushion(s) may comprise the electrically conductive points. The ear cushion may be made conductive by an electrically conductive leatherette used as a cover for the ear cushion. The ear cushion(s) may be connected to the electrical circuit via an inner spring or other direct contact to a frame and headband/neckband cable.

In some embodiments of the method, when the acoustic output transducer is transmitting audio, the method comprises:
in accordance with a determination that the hearing device detects that the hearing device is worn by the user: the acoustic output transducer continues to transmit audio, and
in accordance with a determination that the hearing device detects that the hearing device is not worn by the user: the acoustic output transducer stops to transmit audio.

In some embodiments of the method, the method comprises detecting, by the electrical circuit, when the first electrically conductive point and the second electrically conductive point are in contact with the skin of the user's ear by measuring a difference in electrical voltage and/or electrical resistance between the first electrically conductive point and the second electrically conductive point.

In some embodiments of the method, the method comprises detecting, by the electrical circuit, when the first electrically conductive point and the second electrically conductive point are in contact with the skin of the user's ear by measuring if the difference in electrical voltage electrical voltage and/or electrical resistance between the first electrically conductive point and the second electrically conductive point is above or below a predefined threshold.

In an embodiment, a hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprise in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHZ, preferably a wavelength between 900 MHz and 6 GHz. The first frequency may be 902 MHz to 928 MHz. The first frequency may be 2.4 to 2.5 GHZ. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

The hearing device may be a headset, a hearing aid, a hearable etc. The hearing device may be an in-the-ear (ITE) hearing device, a receiver-in-ear (RIE) hearing device, a receiver-in-canal (RIC) hearing device, a microphone-and-receiver-in-ear (MaRIE) hearing device, a behind-the-ear (BTE) hearing device comprising an ITE unit, or a one-size-fits-all hearing device etc.

The hearing device is configured to be worn by a user. The hearing device may be arranged at the user's ear, on the user's ear, in the user's ear, in the user's ear canal, behind the user's ear etc. The user may wear two hearing devices, one hearing device at each ear. The two hearing devices may be connected, such as wirelessly connected.

The hearing device may be configured for audio communication, e.g. enabling the user to listen to media, such as music or radio, and/or enabling the user to perform phone calls. The hearing device may be configured for performing hearing compensation for the user. The hearing device may be configured for performing noise cancellation etc.

The hearing device may comprise a RIE unit. The RIE unit typically comprises the earpiece such as a housing, a plug connector, and an electrical wire/tube connecting the plug connector and earpiece. The earpiece may comprise an in-the-ear housing, a receiver, such as a receiver configured for being provided in an ear of a user, and an open or closed dome. The dome may support correct placement of the earpiece in the ear of the user. The RIE unit may comprise an input transducer e.g. a microphone or a receiver, an output transducer e.g. an speaker, one or more sensors, and/or other electronics. Some electronic components may be placed in the earpiece, while other electronic components may be placed in the plug connector. The receiver may be with a different strength, i.e. low power, medium power, or high power. The electrical wire/tube provides an electrical connection between electronic components provided in the earpiece of the RIE unit and electronic components provided in the BTE unit. The electrical wire/tube as well as the RIE unit itself may have different lengths.

The hearing device may comprise an output transducer e.g. a speaker or receiver. The output transducer may be a part of a printed circuit board (PCB) of the hearing device. The output transducer may be arranged on a printed circuit board (PCB) of the hearing device. The output transducer may not be a part of the PCB of the hearing device. The output transducer may be configured to be arranged on the PCB of the hearing device. For instance, the output transducer may be configured to be arranged on an allocated position/area on the PCB of the hearing device. The output transducer may be arranged through a hole in the PCB.

The hearing device may comprise a first input transducer, e.g. a microphone, to generate one or more microphone output signals based on a received audio signal. The audio signal may be an analogue signal. The microphone output signal may be a digital signal. Thus, the first input transducer, e.g. microphone, or an analogue-to-digital converter, may convert the analogue audio signal into a digital microphone output signal. All the signals may be sound signals or signals comprising information about sound.

The hearing device may comprise a signal processor. The one or more microphone output signals may be provided to the signal processor for processing the one or more microphone output signals. The signals may be processed such as to compensate for a user's hearing loss or hearing impairment. The signal processor may provide a modified signal. All these components may be comprised in a housing of an ITE unit or a BTE unit. The hearing device may comprise a receiver or output transducer or speaker or loudspeaker. The receiver may be connected to an output of the signal processor. The receiver may output the modified signal into the user's ear. The receiver, or a digital-to-analogue converter, may convert the modified signal, which is a digital signal, from the processor to an analogue signal. The receiver may be comprised in an ITE unit or in an earpiece, e.g. RIE unit or MaRIE unit. The hearing device may comprise more than one microphone, and the ITE unit or BTE unit may comprise at least one microphone and the RIE unit may also comprise at least one microphone.

The hearing device signal processor may comprise elements such as an amplifier, a compressor and/or a noise reduction system etc. The signal processor may be implemented in a signal-processing chip or on the PCB of the hearing device. The hearing device may further have a filter function, such as compensation filter for optimizing the output signal.

The hearing device may comprise one or more antennas for radio frequency communication. The one or more antenna may be configured for operation in ISM frequency band. One of the one or more antennas may be an electric antenna. One or the one or more antennas may be a magnetic induction coil antenna. Magnetic induction, or near-field magnetic induction (NFMI), typically provides communication, including transmission of voice, audio and data, in a range of frequencies between 2 MHz and 15 MHz. At these frequencies the electromagnetic radiation propagates through and around the human head and body without significant losses in the tissue.

The magnetic induction coil may be configured to operate at a frequency below 100 MHZ, such as at below 30 MHz, such as below 15 MHZ, during use. The magnetic induction coil may be configured to operate at a frequency range between 1 MHz and 100 MHZ, such as between 1 MHz and 15 MHz, such as between 1 MHz and 30 MHz, such as between 5 MHz and 30 MHZ, such as between 5 MHz and 15 MHZ, such as between 10 MHz and 11 MHz, such as between 10.2 MHz and 11 MHz. The frequency may further include a range from 2 MHz to 30 MHZ, such as from 2 MHz to 10 MHz, such as from 2 MHz to 10 MHz, such as from 5 MHz to 10 MHZ, such as from 5 MHz to 7 MHz.

The electric antenna may be configured for operation at a frequency of at least 400 MHZ, such as of at least 800 MHZ, such as of at least 1 GHZ, such as at a frequency between 1.5 GHZ and 6 GHz, such as at a frequency between 1.5 GHZ and 3 GHz such as at a frequency of 2.4 GHz. The antenna may be optimized for operation at a frequency of between 400 MHz and 6 GHZ, such as between 400 MHz and 1 GHZ, between 800 MHZ and 1 GHz, between 800 MHz and 6 GHz, between 800 MHZ and 3 GHZ, etc. Thus, the electric antenna may be configured for operation in ISM frequency band. The electric antenna may be any antenna capable of operating at these frequencies, and the electric antenna may be a resonant antenna, such as monopole antenna, such as a dipole antenna, etc. The resonant antenna may have a length of λ/4±10% or any multiple thereof, A being the wavelength corresponding to the emitted electromagnetic field.

The hearing device may comprise one or more wireless communications unit(s) or radios. The one or more wireless communications unit(s) are configured for wireless data communication, and in this respect interconnected with the one or more antennas for emission and reception of an electromagnetic field. Each of the one or more wireless communication unit may comprise a transmitter, a receiver, a transmitter-receiver pair, such as a transceiver, and/or a radio unit. The one or more wireless communication units may be configured for communication using any protocol as known for a person skilled in the art, including Bluetooth, WLAN standards, manufacture specific protocols, such as tailored proximity antenna protocols, such as proprietary protocols, such as low-power wireless communication protocols, RF communication protocols, magnetic induction protocols, etc. The one or more wireless communication units may be configured for communication using same communication protocols, or same type of communication protocols, or the one or more wireless communication units may be configured for communication using different communication protocols.

The wireless communication unit may connect to the hearing device signal processor and the antenna, for communicating with one or more external devices, such as one or more external electronic devices, including at least one smart phone, at least one tablet, at least one hearing accessory device, including at least one spouse microphone, remote control, audio testing device, etc., or, in some embodiments, with another hearing device, such as another hearing device located at another ear, typically in a binaural hearing device system.

The hearing device may be a binaural hearing device. The hearing device may be a first hearing device and/or a second hearing device of a binaural hearing device.

The hearing device may be a device configured for communication with one or more other device, such as configured for communication with another hearing device or with an accessory device or with a peripheral device.

The present invention relates to different aspects including the hearing device and the method described above and in the following, and corresponding systems, devices, device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary hearing device configured to detect if the hearing device is being worn by a user.

FIG. 2 schematically illustrates an exemplary electrical circuit in contact with the first electrically conductive point and the second electrically conductive point.

FIG. 3 schematically illustrates an exemplary hearing device being a headset for transmitting audio from and/or to an external electronic device connected to the headset.

FIG. 4 schematically illustrates an exemplary hearing device where the first electrically conductive point and/or the second electrically conductive point are arranged on the housing of an in-ear hearing device.

FIG. 5a-5b schematically illustrates an exemplary hearing device where the first electrically conductive point and/or the second electrically conductive point are arranged on an earwing and/or on an eargel arranged on the in-ear hearing device.

FIGS. 6a, 6b, and 6c schematically illustrates an exemplary hearing device where the first electrically conductive point and/or the second electrically conductive point are arranged on a first earphone and/or on a second earphone of the housing of an on-ear or an over-ear hearing device.

FIG. 7 schematically illustrates an example with an exemplary electrical circuit in a hearing device where the first electrically conductive point and the second electrically conductive point are arranged on a first earphone and on a second earphone, respectively, of the housing(s) of an on-ear or an over-ear hearing device.

FIGS. 8a and 8b schematically illustrates an example with an exemplary hearing device where the first electrically conductive point is arranged on an earwing and the second electrically conductive point is arranged on an eargel arranged on the in-ear hearing device.

FIGS. 9a and 9b schematically illustrates an example with an exemplary hearing device where the first electrically conductive point is arranged on an earwing and the second electrically conductive point is arranged on an eargel arranged on the in-ear hearing device.

FIGS. 10a, 10b and 10c schematically illustrates an example with an exemplary hearing device where the first electrically conductive point is arranged on an earwing and the second electrically conductive point is arranged on an eargel arranged on the in-ear hearing device.

FIGS. 11a, 11b and 11c schematically illustrates an example with an exemplary hearing device where the first electrically conductive point is arranged on an earwing and the second electrically conductive point is arranged on an eargel arranged on the in-ear hearing device.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

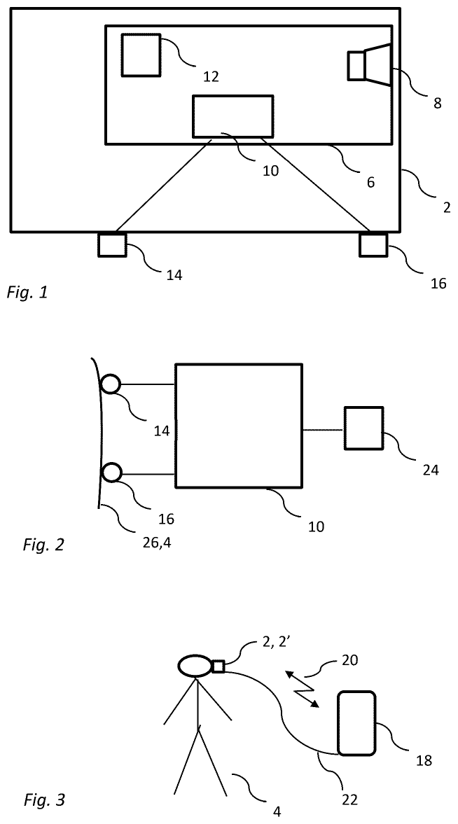

FIG. 1 schematically illustrates an exemplary hearing device 2 configured to detect if the hearing device 2 is being worn by a user 4. The hearing device 2 being configured to be worn on an ear or in an ear of the user. The hearing device 2 comprises a housing 6. The hearing device 2 comprises an acoustic output transducer 8 for transmitting audio into the ear of the user 4. The acoustic output transducer 8 being arranged in the housing 6. The hearing device 2 comprises an electrical circuit 10 arranged in the housing 6. The hearing device 2 comprises a battery 12 arranged in the housing 6. The hearing device 2 comprises a first electrically conductive point 14 and a second electrically conductive point 16. The first electrically conductive point 14 and the second electrically conductive point 16 are arranged to be in contact with the skin of the user's 4 ear, when the user 4 is wearing the hearing device 2 in its intended operational position on/in the ear. The electrical circuit 10 is configured to detect when the first electrically conductive point 14 and the second electrically conductive point 16 are in contact with the skin of the user's 4 ear, whereby the hearing device 2 detects whether the hearing device 2 is worn by the user.

When the acoustic output 8 transducer is transmitting audio, then:
in accordance with a determination that the hearing device 2 detects that the hearing device 2 is worn by the user 4: the acoustic output transducer 8 may continue to transmit audio, and
in accordance with a determination that the hearing device 2 detects that the hearing device 2 is not worn by the user 4: the acoustic output transducer 8 may stop to transmit audio.

FIG. 2 schematically illustrates an exemplary electrical circuit 10 in contact with the first electrically conductive point 14 and the second electrically conductive point 16, whereby the electrical circuit 10 is configured to detect when the first electrically conductive point 14 and the second electrically conductive point 16 are in contact with the skin 26 of the user's ear. The first electrically conductive point 14 and the second electrically conductive point 16 may be connected to the electrical circuit 10 via a metal contact on a frame. The electrical circuit 10 is connected to a micro control unit (MCU) 24 configured to control and determine actions and functions of the hearing device.

The electrical circuit 10 may be configured to detect when the first electrically conductive point 14 and the second electrically conductive point 16 are in contact with the skin 26 of the user's ear by measuring a difference in electrical voltage and/or in electrical resistance between the first electrically conductive point 14 and the second electrically conductive point 16.

The electrical circuit 10 may be configured to detect when the first electrically conductive point 14 and the second electrically conductive point 16 are in contact with the skin 26 of the user's ear by measuring if the difference in electrical voltage and/or in electrical resistance between the first electrically conductive point 14 and the second electrically conductive point 16 is above or below a predefined threshold. The predefined threshold may be different for men, women, children. The predefined threshold may be different for different weather temperature. The predefined threshold may be different when the user is doing sport compared to when the user it not doing sport, because the skin resistance will be lower if the user sweats. Thus the predefined threshold may be a setting in the hearing device which can be adapted relative to information regarding the gender, age, country of residence, activity level etc. of the user.

The first electrically conductive point 14 and the second electrically conductive point 16 may be made of an electrically conductive material.

The electrically conductive material may be an electrically conductive silicone, or an electrically conductive rubber, or an electrically conductive leatherette.

FIG. 3 schematically illustrates an exemplary hearing device 2 being a headset 2′ for transmitting audio from and/or to an external electronic device 18 connected to the headset 2′. The external electronic device 18 may be a smartphone, tablet, computer, pc etc. The connection between the hearing device 2 and the electronic device 18 may be a wireless connection 20, such as via Bluetooth (BT), Wi-Fi, WLAN etc. or a wired connection 22 via a cable. The transmitted audio may be media content, such as radio, music, podcast, audio book etc., and/or speech signals to the user 4 in a phone call with a far-end caller.

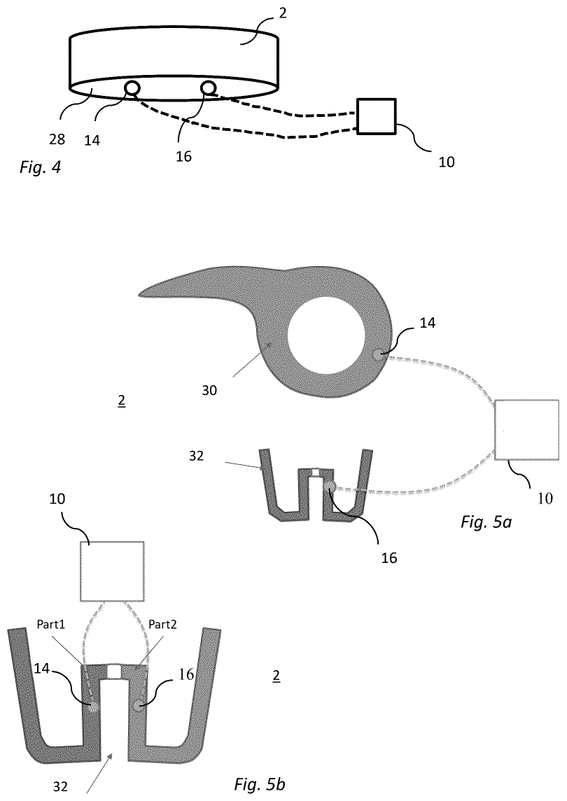

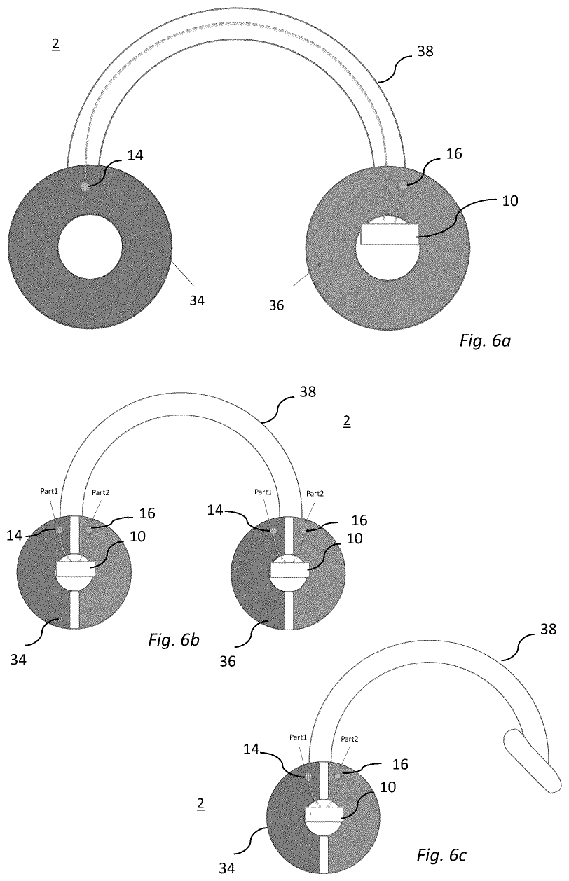

As shown in FIGS. 4, 5a, 5b, 6a, 6b and 6c, the hearing device 2 may be an in-ear hearing device (FIGS. 4 and 5a-5b), or an on-ear hearing device (FIG. 6a-6c), or an over-ear hearing device (FIG. 6a-6c). Thus, the hearing device 2 may be configured to be worn on an ear or in an ear of the user. If the hearing device 2 is an on-ear or over-ear hearing device, the earphone(s) of the hearing device is/are arranged on the ear of the user. If the hearing device is an in-ear hearing device, the earphone(s) of the hearing device is/are arranged in the ear of the user, such as in the ear canal. The hearing device may comprise one or two earphones. The earphone(s) may be circumaural, supra-aural etc. Earphones may also be called earbuds. On the hearing device, housing and/or earphone, there may be attached an eargel or dome, an earwing or retention etc., as seen in FIG. 5a-5b.

All of FIGS. 4, 5a, 5b, 6a, 6b and 6c show that the first electrically conductive point 14 and the second electrically conductive point 16 are connected to the electrical circuit 10.

FIG. 4 schematically illustrates an exemplary hearing device 2 where the first electrically conductive point 14 and/or the second electrically conductive point 16 are arranged on the housing 6 of an in-ear hearing device 2. The first electrically conductive point 14 and/or the second electrically conductive point 16 may be made of a conductive material. The conductive material, e.g. silicone, can be put on the back cover 28 of the hearing device 2, e.g. earbud, as accessories. Or the conductive material, e.g. silicone, can be over-molded to the back cover 28 especially for non-earwing design.

FIG. 5a-5b schematically illustrates an exemplary hearing device 2 where the first electrically conductive point 14 and/or the second electrically conductive point 16 are arranged on an earwing 30 and/or on an eargel 32 arranged on the in-ear hearing device 2. For example, both electrically conductive points 14, 16 are arranged on an earwing 30 of the hearing device 2. For example, as shown in FIG. 5b, both electrically conductive points 14, 16 are arranged on an eargel 32 of the hearing device 2. In these cases, the eargel, or earwing, itself can be divided into two parts, part 1 and part 2, each part comprising one electrically conductive point. For example, as shown in FIG. 5a, one electrically conductive point 14 is arranged on an eargel 32 and the other electrically conductive point 16 is arranged on an earwing 30. Alternatively, one electrically conductive point is arranged on the housing, such as on the back cover as shown in FIG. 4, and the other electrically conductive point is arranged on either an earwing 30 or an eargel 32 of the hearing device 2.

FIGS. 6a, 6b, and 6c schematically illustrates an exemplary hearing device 2 where the first electrically conductive point 14 and/or the second electrically conductive point 16 are arranged on a first earphone 34 and/or on a second earphone 36 of the housing of an on-ear or an over-ear hearing device 2. The first earphone 34 and the second earphone 36 may be connected by a headband 38 or a neckband (not shown).

For example, as shown in FIG. 6a, one electrically conductive point 14 is arranged on the first earphone 34 and the other electrically conductive point 16 is arranged on the second earphone 36.

For example, as shown in FIGS. 6b and 6c, both electrically conductive points 14, 16 are arranged on the first earphone 34, and/or both electrically conductive points 14, 16 are arranged on the second earphone 36. In these cases, the earphone 34, 36 or ear cushion itself can be divided to two parts, part 1 and part 2, each part comprising one electrically conductive point. This can be used in both mono headset, as shown in FIG. 6c, and stereo headset, as shown in FIG. 6b.

The first earphone 34 and/or the second earphone 36 may comprise an ear cushion. The ear cushion(s) may comprise the electrically conductive points 14, 16. The ear cushion may be made conductive by an electrically conductive leatherette used as a cover for the ear cushion. The ear cushion(s) may be connected to the electrical circuit 10 via an inner spring or other direct contact to a frame and a headband/neckband cable.

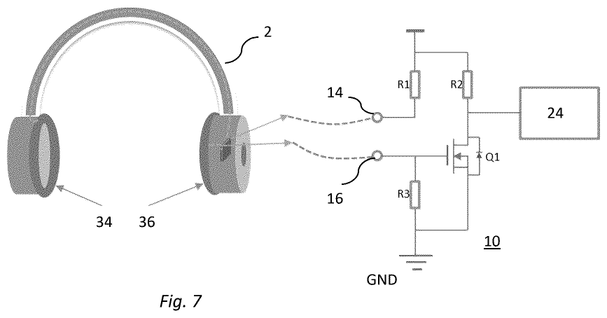

FIGS. 7, 8a-8b, 9a-9b, 10a-10c and 11-a-11c schematically illustrate examples with an exemplary electrical circuit 10 in a hearing device 2 with a first electrically conductive point 14 and a second electrically conductive point 16. The electrical circuit 10 is configured to detect when the first electrically conductive point 14 and the second electrically conductive point 16 are in contact with the skin of the user's 4 ear. This detection may be performed in different ways, such as by detecting electrical voltage, detecting electrical resistance, detecting at one point, detecting at different points, detecting a difference, detecting a change etc.

Thus, the electrical circuit may be configured to detect when the first electrically conductive point and the second electrically conductive point are in contact with the skin of the user's ear by measuring a difference in electrical voltage and/or electrical resistance between the first electrically conductive point and the second electrically conductive point.

The electrical circuit may be configured to detect when the first electrically conductive point and the second electrically conductive point are in contact with the skin of the user's ear by measuring a change in electrical voltage and/or in electrical resistance at the first electrically conductive point or at second electrically conductive point.

The electrical circuit may be configured to detect when the first electrically conductive point and the second electrically conductive point are in contact with the skin of the user's ear by measuring if the difference in electrical voltage and/or electrical resistance between the first electrically conductive point and the second electrically conductive point is above or below a predefined threshold.

The electrical circuit may be configured to detect when the first electrically conductive point and the second electrically conductive point are in contact with the skin of the user's ear by measuring if the change in electrical voltage and/or in electrical resistance at the first electrically conductive point or at the second electrically conductive point is above or below a predefined threshold.

FIG. 7 schematically illustrates an example with an exemplary electrical circuit 10 in a hearing device 2 where the first electrically conductive point 14 and the second electrically conductive point 16 are arranged on a first earphone 34 and on a second earphone 36, respectively, of the housing(s) of an on-ear or an over-ear hearing device 2.

In FIG. 7, the conductive/current loop of the electrical circuit 10 is open when the hearing device 2 is not on an ear of a user, thus the Q1 is off, and the micro control unit (MCU) 24 detects a higher voltage signal level. Q1 may be an N channel MOSFET (N-MOSFET), e.g. like a transistor, but which may be voltage driven to optimize consumption. When the user wears the hearing device 2 on the head and ears, the loop is closed, because the human ear and head are electrically conductive. Q1 will drain to ground (GND), and the MCU 24 detects a lower voltage signal level. In summary, the MCU 24 obtains the wearing state by detecting a higher or lower voltage signal level of the Q1 output and based on this, determines the function of the hearing device 2. The electrical circuit comprises a number of resistors, R1, R2, R3.

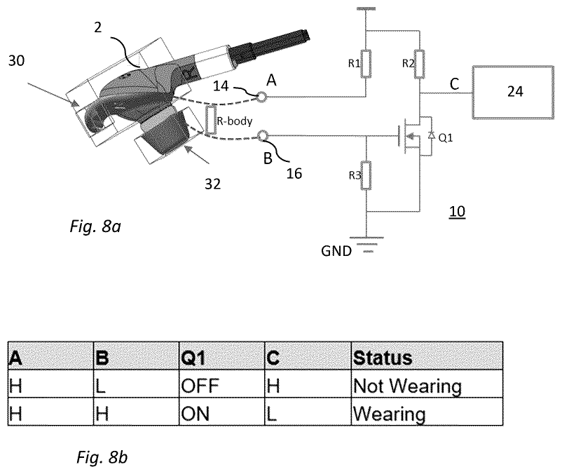

FIGS. 8a and 8b schematically illustrates an example with an exemplary hearing device 2 where the first electrically conductive point 14 is arranged on an earwing 30 and the second electrically conductive point 16 is arranged on an eargel 32 arranged on the in-ear hearing device 2.

In FIG. 8a, the conductive/current loop of the electrical circuit 10 is open when the hearing device 2 is not in an ear of a user, thus the Q1 is off, and the micro control unit (MCU) 24 detects a higher voltage signal level. Q1 may be an N channel MOSFET (N-MOSFET), e.g. like a transistor, but which may be voltage driven to optimize consumption. When the user wears the hearing device 2 in the ear, the loop is closed, because the human ear is electrically conductive. Q1 will drain to ground (GND), and the MCU 24 detects a lower voltage signal level. In summary, the MCU 24 obtains the wearing state by detecting a higher or lower voltage signal level of the Q1 output and based on this, determines the function of the hearing device 2. The electrical circuit comprises a number of resistors, R1, R2, R3.

FIG. 8b shows an example of a table showing wearing status of the hearing device based on detection of high (H) or low (L) voltage at different points in the electrical circuit 10 (see FIG. 8a). The electrical circuit may be an N-MOSFET circuit.

The top row in the table shows a situation where the hearing device is not being worn, and here point A keeps a HIGH voltage, point B is LOW voltage, so that Q1 (N-MOS) is OFF. The MCU detects point C to be HIGH, and therefore detects that the wearing state of the hearing device is “not wearing”.

The bottom row in the table shows a situation where the hearing device is now in the ear of the user, and as the human body is electrically conductive, just like a body-resistor connected point A and point B, that will pull point B to HIGH, and point A is HIGH, so that Q1 is ON. The MCU detects point C to be LOW, and therefore detects that the wearing state of the hearing device is “wearing”.

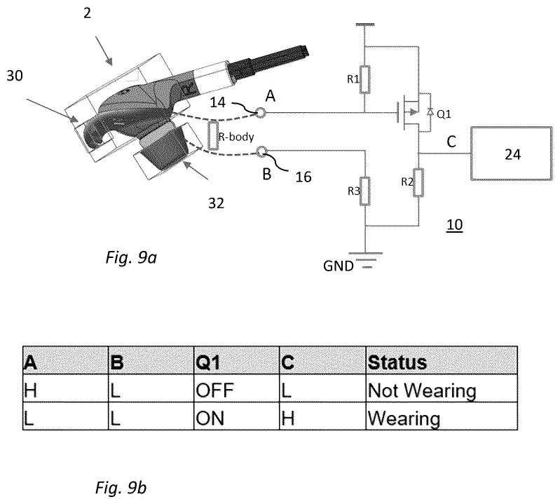

FIGS. 9a and 9b schematically illustrates an example with an exemplary hearing device 2 where the first electrically conductive point 14 is arranged on an earwing 30 and the second electrically conductive point 16 is arranged on an eargel 32 arranged on the in-ear hearing device 2.

In FIG. 9a, the conductive/current loop of the electrical circuit 10 is open when the hearing device 2 is not in an ear of a user, thus the Q1 is off, and the micro control unit (MCU) 24 detects a lower voltage signal level. Q1 may be a P channel MOSFET (P-MOSFET), e.g. like a transistor, but which may be voltage driven to optimize consumption When the user wears the hearing device 2 in the ear, the loop is closed, because the human ear is electrically conductive. Q1 will pull up to power VCC, so that point C is high voltage, and the MCU 24 detects a higher voltage signal level. In summary, the MCU 24 obtains the wearing state by detecting a higher or lower voltage signal level of the Q1 output and based on this, determines the function of the hearing device 2. The electrical circuit comprises a number of resistors, R1, R2, R3.

FIG. 9b shows an example of a table showing wearing status of the hearing device based on detection of high (H) or low (L) voltage at different points in the electrical circuit 10 (see FIG. 9a). The electrical circuit may be a P-MOSFET circuit.

The top row in the table shows a situation where the hearing device is not being worn, and here point A, i.e. the first electrically conductive point 14, keeps a HIGH voltage, point B, i.e. the second electrically conductive point 16, is LOW voltage, so that Q1 (P-MOS) is OFF. The MCU detects point C to be LOW, and therefore detects that the wearing state of the hearing device is “not wearing”.

The bottom row in the table shows a situation where the hearing device is now in the ear of the user, and as the human body is electrically conductive, just like a body-resistor connected point A, i.e. the first electrically conductive point 14, and point B, i.e. the second electrically conductive point 16, that will pull point A, i.e. the first electrically conductive point 14, to LOW, and point B, i.e. the second electrically conductive point 16, is LOW, so that Q1 is ON. The MCU detects point C to be HIGH, and therefore detects that the wearing state of the hearing device is “wearing”.

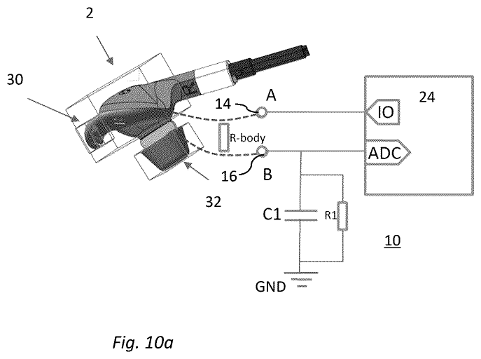

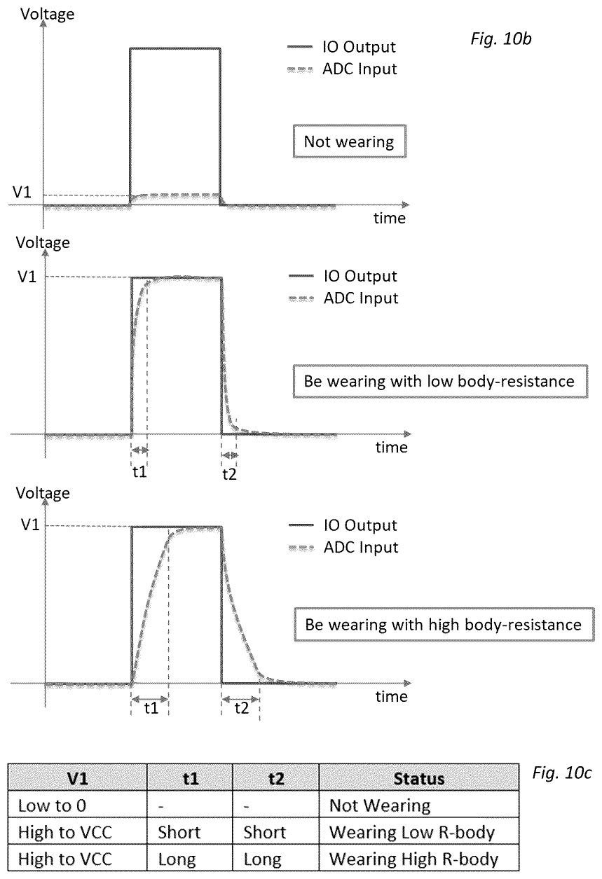

FIGS. 10a, 10b and 10c schematically illustrates an example with an exemplary hearing device 2 where the first electrically conductive point 14 is arranged on an earwing 30 and the second electrically conductive point 16 is arranged on an eargel 32 arranged on the in-ear hearing device 2.

In FIG. 10a, the body-resistor (R-body) and capacitor C1 form an R-C charging/discharging circuit. The electrical circuit 10 may comprise a resistor R1. In FIG. 10a, the MCU 24 comprises an input-output port (IO) and an analog-to-digital converter (ADC).

FIG. 10b shows an example of three graphs where time is on the x-axis and voltage is on the y-axis. The top graph shows a situation when the wearing state is “not wearing.” The middle graph shows a situation where the wearing state is “wearing with low body-resistance”. The bottom graph shows a situation where the wearing state is “wearing with high body-resistance”.

FIG. 10c shows an example of a table showing wearing status of the hearing device based on detection of change/difference in voltage in the electrical circuit 10 (see FIG. 10a). The electrical circuit may be a R-C charging/discharging circuit.

The top graph in FIG. 10b and the top row in FIG. 10c shows a situation where the hearing device is not being worn. Point A, i.e. the first electrically conductive point 14, and point B, i.e. the second electrically conductive point 16, are disconnected. The ADC input of the MCU 24 can read very low voltage.

The middle graph in FIG. 10b and the middle row in FIG. 10c shows a situation where the hearing device is in the ear, and as the human body is electrically conductive, just like a body-resistor connect point A, i.e. the first electrically conductive point 14, and point B, i.e. the second electrically conductive point 16, there will be current from the IO output to the ADC input. The MCU 24 can receive some voltage. This shows a situation where the wearing state is “wearing with low body-resistance”.

The bottom graph in FIG. 10b and the bottom row in FIG. 10c shows a situation where the hearing device is in the ear. Because of charging current through R-body to C1, the voltage at point B, i.e. the second electrically conductive point 16, will not abruptly increase. So the MCU 24 can capture the rise time. This shows a situation where the wearing state is “wearing with high body-resistance”.

Different users and/or or different temperatures may make the human body resistance different, so as the rise time. The MCU 24 can adapt the threshold based on temperature and/or user setting.

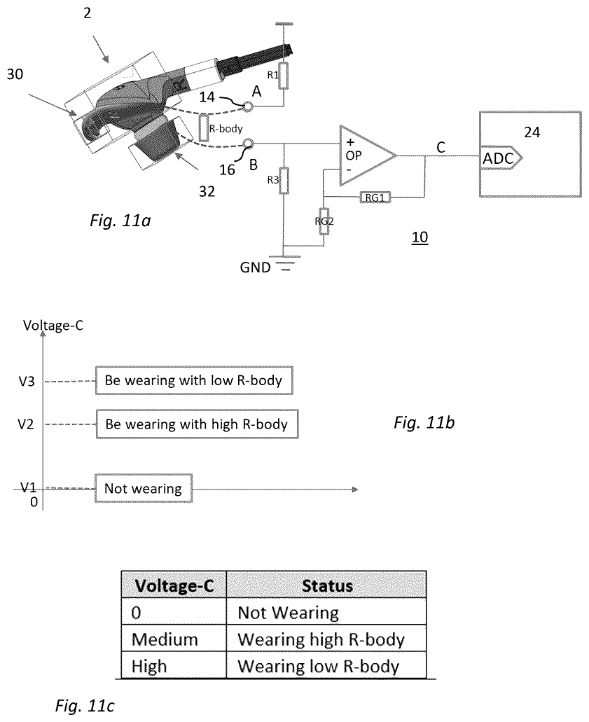

FIGS. 11a, 11b and 11c schematically illustrates an example with an exemplary hearing device 2 where the first electrically conductive point 14 is arranged on an earwing 30 and the second electrically conductive point 16 is arranged on an eargel 32 arranged on the in-ear hearing device 2.

In FIG. 11a, the electrical circuit 10 comprises an operational amplifier (OP). The gain of operational amplifier is β=1+RG1/RG2. It is used to amplify point B, i.e. the second electrically conductive point 16, voltage. Voltage at point C=(1+RG1/RG2)*Voltage B. The electrical circuit 10 may comprise resistors R1, R3, RG1, RG2. In FIG. 11a, the MCU 24 comprises an analog-to-digital converter (ADC).

FIG. 11b shows an example of a graph where the voltage at point C is indicated on the y-axis. In the bottom of the graph, the voltage is V1=0 and this shows a situation when the wearing state is “not wearing.” In the middle of the graph, the voltage is V2=low and this shows a situation where the wearing state is “wearing with high body-resistance”. In the top of the graph, the voltage V3=high and this shows a situation where the wearing state is “wearing with low body-resistance”.

FIG. 11c shows an example of a table showing wearing status of the hearing device based on detection of voltage at point C in the electrical circuit 10 (see FIG. 11a). The electrical circuit may be an operational amplifier (OP) circuit.

The bottom of the graph in FIG. 11b and the top row in FIG. 11c shows a situation where the hearing device is not being worn. Point A, i.e. the first electrically conductive point 14, keeps in HIGH voltage, point B, i.e. the second electrically conductive point 16, is zero voltage. The operational amplifier outputs zero voltage. The MCU 24 detects point C to be zero voltage, and therefore detects that the wearing state of the hearing device is “not wearing”.

The middle of the graph in FIG. 11b and the middle row in FIG. 11c shows a situation where the hearing device is in the ear, and as the human body is electrically conductive, just like a body-resistor connect point A, i.e. the first electrically conductive point 14, and point B, i.e. the second electrically conductive point 16, that will pull point B, i.e. the second electrically conductive point 16, to a bit higher voltage, it is amplified by the OP and the MCU 24 can detect a higher voltage V2, and therefore detects that the wearing state of the hearing device is “wearing with high body-resistance”.

The top graph in FIG. 11b and the bottom row in FIG. 11c shows a situation where the hearing device is in the ear as above. The MCU can detect a higher voltage V3, and therefore detects that the wearing state of the hearing device is “wearing with low body-resistance”.

Different user or different temperature may lead the human body resistance different, so as the OP output voltage. The MCU can adapt the threshold based on temperature and/or user setting.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items:

1. A hearing device configured to detect if the hearing device is being worn by a user, the hearing device being configured to be worn on an ear or in an ear of the user, the hearing device comprising:
   a housing;
   an acoustic output transducer for transmitting audio into the ear of the user, the acoustic output transducer being arranged in the housing;
   an electrical circuit arranged in the housing;
   a battery arranged in the housing;
wherein the hearing device comprises a first electrically conductive point and a second electrically conductive point, where the first electrically conductive point and the second electrically conductive point are arranged to be in contact with the skin of the user's ear, when the user is wearing the hearing device in its intended operational position on/in the ear of the user;
wherein the electrical circuit is configured to detect when the first electrically conductive point and the second electrically conductive point are in contact with the skin of the user's ear, whereby the hearing device detects whether the hearing device is worn by the user.
2. The hearing device according to any of the preceding items, wherein when the acoustic output transducer is transmitting audio, then:
   in accordance with a determination that the hearing device detects that the hearing device is worn by the user: the acoustic output transducer continues to transmit audio, and
   in accordance with a determination that the hearing device detects that the hearing device is not worn by the user: the acoustic output transducer stops to transmit audio.
3. The hearing device according to any of the preceding items, wherein the electrical circuit is configured to detect when the first electrically conductive point and the second electrically conductive point are in contact with the skin of the user's ear by measuring a difference in electrical voltage and/or electrical resistance between the first electrically conductive point and the second electrically conductive point.
4. The hearing device according to any of the preceding items, wherein the electrical circuit is configured to detect when the first electrically conductive point and the second electrically conductive point are in contact with the skin of the user's ear by measuring a change in electrical voltage and/or in electrical resistance at the first electrically conductive point or at second electrically conductive point.
5. The hearing device according to the preceding item, wherein the electrical circuit is configured to detect when the first electrically conductive point and the second electrically conductive point are in contact with the skin of the user's ear by measuring if the difference in electrical voltage and/or electrical resistance between the first electrically conductive point and the second electrically conductive point is above or below a predefined threshold.
6. The hearing device according to the preceding item, wherein the electrical circuit is configured to detect when the first electrically conductive point and the second electrically conductive point are in contact with the skin of the user's ear by measuring if the change in electrical voltage and/or in electrical resistance at the first electrically conductive point or at the second electrically conductive point is above or below a predefined threshold.
7. The hearing device according to any of the preceding items, wherein the first electrically conductive point and the second electrically conductive point are made of an electrically conductive material.
8. The hearing device according to the preceding item, wherein the electrically conductive material is an electrically conductive silicone, or an electrically conductive rubber, or an electrically conductive leatherette.
9. The hearing device according to any of the preceding items, wherein the hearing device is a headset for transmitting audio from and/or to an external electronic device connected to the headset.
10. The hearing device according to any of the preceding items, wherein the hearing device is an in-ear hearing device, or an on-ear hearing device, or an over-ear hearing device.
11. The hearing device according to any of the preceding items, wherein the first electrically conductive point and/or the second electrically conductive point are arranged on the housing of an in-ear hearing device.
12. The hearing device according to any of the preceding items, wherein the first electrically conductive point and/or the second electrically conductive point are arranged on an earwing and/or on an eargel arranged on an in-ear hearing device.
13. The hearing device according to any of the preceding items, wherein the first electrically conductive point and/or the second electrically conductive point are arranged on a first earphone and/or on a second earphone of the housing of an on-ear or an over-ear hearing device.
14. A method in a hearing device for detecting if the hearing device is being worn by a user, the hearing device being configured to be worn on an ear or in an ear of the user, the hearing device comprising:
   a housing;
   an acoustic output transducer for transmitting audio into the ear of the user, the acoustic output transducer being arranged in the housing;
   an electrical circuit arranged in the housing;
   a battery arranged in the housing;
wherein the hearing device comprises a first electrically conductive point and a second electrically conductive point, where the first electrically conductive point and the second electrically conductive point are arranged to be in contact with the skin of the user's ear, when the user is wearing the hearing device in its intended operational position on/in the ear of the user;
wherein the method comprises detecting, by the electrical circuit, when the first electrically conductive point and the second electrically conductive point are in contact with the skin of the user's ear, whereby the hearing device detects whether the hearing device is worn by the user.
15. The method according to item 14, wherein when the acoustic output transducer is transmitting audio, the method comprises:
   in accordance with a determination that the hearing device detects that the hearing device is worn by the user: the acoustic output transducer continues to transmit audio, and
   in accordance with a determination that the hearing device detects that the hearing device is not worn by the user: the acoustic output transducer stops to transmit audio.
16. The method according to item 14 or 15, wherein the method comprises detecting, by the electrical circuit, when the first electrically conductive point and the second electrically conductive point are in contact with the skin of the user's ear by measuring a difference in electrical voltage electrical voltage and/or electrical resistance between the first electrically conductive point and the second electrically conductive point.
17. The method according to the preceding item, wherein the method comprises detecting, by the electrical circuit, when the first electrically conductive point and the second electrically conductive point are in contact with the skin of the user's ear by measuring if the difference in electrical voltage electrical voltage and/or electrical resistance between the first electrically conductive point and the second electrically conductive point is above or below a predefined threshold.

### LIST OF REFERENCES

2 hearing device
2′ headset
4 user
6 housing
8 acoustic output transducer
10 electrical circuit
12 battery
14 first electrically conductive point
16 second electrically conductive point
18 external electronic device
20 wireless connection
22 wired connection
24 micro control unit (MCU)
26 skin of the user's ear
28 back cover
30 earwing
32 eargel
34 first earphone
36 second earphone
38 headband
Q1 N channel MOSFET (N-MOSFET) or P channel MOSFET (P-MOSFET)
GND ground
R1, R2, R3 resistors
RG1, RG2 resistors
OP operational amplifier
ADC analog-to-digital converter
IO input/output port
R-body body resistance
C1 capacitor

1. A hearing device configured to detect if the hearing device is being worn by a user, the hearing device being configured to be worn on an ear or in an ear of the user, the hearing device comprising:
a housing;
an acoustic output transducer for transmitting audio into the ear of the user, the acoustic output transducer being arranged in the housing;
an electrical circuit arranged in the housing;
a battery arranged in the housing;
wherein the hearing device comprises a first electrically conductive point and a second electrically conductive point, where the first electrically conductive point and the second electrically conductive point are arranged to be in contact with the skin of the user's ear, when the user is wearing the hearing device in its intended operational position on/in the ear of the user;
wherein the first electrically conductive point and the second electrically conductive point are made of an electrically conductive material, and wherein the electrically conductive material is an electrically conductive silicone; and
wherein the electrical circuit is configured to detect when the first electrically conductive point and the second electrically conductive point are in contact with the skin of the user's ear, whereby the hearing device detects whether the hearing device is worn by the user.

2. The hearing device according to claim 1, wherein when the acoustic output transducer is transmitting audio, then:
in accordance with a determination that the hearing device detects that the hearing device is worn by the user: the acoustic output transducer continues to transmit audio, and
in accordance with a determination that the hearing device detects that the hearing device is not worn by the user: the acoustic output transducer stops to transmit audio.

3. The hearing device according to claim 1, wherein the electrical circuit is configured to detect when the first electrically conductive point and the second electrically conductive point are in contact with the skin of the user's ear by measuring a difference in electrical voltage and/or electrical resistance between the first electrically conductive point and the second electrically conductive point.

4. The hearing device according to claim 1, wherein the electrical circuit is configured to detect when the first electrically conductive point and the second electrically conductive point are in contact with the skin of the user's ear by measuring a change in electrical voltage and/or in electrical resistance at the first electrically conductive point or at second electrically conductive point.

5. The hearing device according to claim 4, wherein the electrical circuit is configured to detect when the first electrically conductive point and the second electrically conductive point are in contact with the skin of the user's ear by measuring if the difference in electrical voltage and/or electrical resistance between the first electrically conductive point and the second electrically conductive point is above or below a predefined threshold.

6. The hearing device according to claim 5, wherein the electrical circuit is configured to detect when the first electrically conductive point and the second electrically conductive point are in contact with the skin of the user's ear by measuring if the change in electrical voltage and/or in electrical resistance at the first electrically conductive point or at the second electrically conductive point is above or below a predefined threshold.

7. The hearing device according to claim 1, wherein the hearing device is a headset for transmitting audio from and/or to an external electronic device connected to the headset.

8. The hearing device according to claim 1, wherein the hearing device is an in-ear hearing device, or an on-ear hearing device, or an over-ear hearing device.

9. The hearing device according to claim 1, wherein the first electrically conductive point and/or the second electrically conductive point are arranged on the housing of an in-ear hearing device.

10. The hearing device according to claim 1, wherein the first electrically conductive point and/or the second electrically conductive point are arranged on an earwing and/or on an eargel arranged on an in-ear hearing device.

11. The hearing device according to claim 1, wherein the first electrically conductive point and/or the second electrically conductive point are arranged on a first earphone and/or on a second earphone of the housing of an on-ear or an over-ear hearing device.

12. A method in a hearing device for detecting if the hearing device is being worn by a user, the hearing device being configured to be worn on an ear or in an ear of the user, the hearing device comprising:
a housing;
an acoustic output transducer for transmitting audio into the ear of the user, the acoustic output transducer being arranged in the housing;
an electrical circuit arranged in the housing;
a battery arranged in the housing;
wherein the hearing device comprises a first electrically conductive point and a second electrically conductive point, where the first electrically conductive point and the second electrically conductive point are arranged to be in contact with the skin of the user's ear, when the user is wearing the hearing device in its intended operational position on/in the ear of the user;
wherein the first electrically conductive point and the second electrically conductive point are made of an electrically conductive material, and wherein the electrically conductive material is an electrically conductive silicone; and
wherein the method comprises detecting, by the electrical circuit, when the first electrically conductive point and the second electrically conductive point are in contact with the skin of the user's ear, whereby the hearing device detects whether the hearing device is worn by the user.

13. The method according to claim 12, wherein when the acoustic output transducer is transmitting audio, the method comprises:
in accordance with a determination that the hearing device detects that the hearing device is worn by the user: the acoustic output transducer continues to transmit audio, and
in accordance with a determination that the hearing device detects that the hearing device is not worn by the user: the acoustic output transducer stops to transmit audio.

14. The method according to claim 12, wherein the method comprises detecting, by the electrical circuit, when the first electrically conductive point and the second electrically conductive point are in contact with the skin of the user's ear by measuring a difference in electrical voltage electrical voltage and/or electrical resistance between the first electrically conductive point and the second electrically conductive point.

15. The method according to claim 14, wherein the method comprises detecting, by the electrical circuit, when the first electrically conductive point and the second electrically conductive point are in contact with the skin of the user's ear by measuring if the difference in electrical voltage electrical voltage and/or electrical resistance between the first electrically conductive point and the second electrically conductive point is above or below a predefined threshold.
